(19) United States
(12) Patent Application Publication
(10) Pub. No.: US 2015/0336241 A1
(43) Pub. Date: Nov. 26, 2015

(54) SOFT JAW FOR A MACHINE VISE

(71) Applicant: Eddy ENGIBAROV, Las Vegas, NV (US)

(72) Inventor: Eddy ENGIBAROV, Las Vegas, NV (US)

(21) Appl. No.: 14/286,147

(22) Filed: May 23, 2014

(51) Int. Cl. B25B 1/24

(52) U.S. Cl. CPC B25B 1/2405

(57) ABSTRACT

A jaw assembly for use on a slideway in which no fasteners or mounting members are required to mount and demount the jaw from the assembly. The jaw assembly may also include a removable jaw to allow the gripping surface of the jaw assembly to be easily changed.

### FIELD OF THE INVENTION

The present invention relates in general to vises, and particularly to a wedge-driven sliding jaw for use in precision machinery.

### BACKGROUND OF THE INVENTION

Workpieces are typically held in place on a machining table with a vise having a fixed or “hard” jaw and a movable or “soft” jaw. Examples of such vises are disclosed in U.S. Pat. Nos. 5,060,920 and 6,126,158, each of which is incorporated herein by reference. Although these vises function well, their structure and assembly can be somewhat involved.

Accordingly, what is needed is a precision vise having a relatively simplified construction, yet which provides accurate placement and retention of a workpiece on a machine table during machining operations such as milling, grinding, drilling, etc.

A further need exists for such a vise which provide little lateral movement as the soft jaw engages the workpiece facilitates rapid removal and replacement of soft jaw on a jaw holder.

Another need exists for such a soft jaw which does not stick to allow the workpiece to easily be removed or replaced.

Another need exists for such a soft jaw which can easily be changed to accommodate a variety of workpieces.

### SUMMARY OF THE INVENTION

The present invention has been developed to meet the needs noted above and therefore has an object to provide a soft jaw assembly for a vise having a relatively simple construction and assembly.

Another object of the invention is to provide a soft jaw assembly which mounts a soft jaw to a jaw holder with a simple interlocking free-sliding fit.

Still another object of the invention is to provide a soft jaw assembly which resists lateral movement when securing a workpiece.

Yet another object of the invention to provide a soft jaw which interlocks with a ledge of a jaw holder without the need for complex interconnections.

Another object of the present invention to provide an adaptable soft jaw assembly that permits a quick change of the jaw's gripping surface.

Another object of the present invention is to provide an adaptable jaw assembly to obviate the need for an expensive inventory of jaw assemblies.

Another object of the present invention is to provide an adaptable jaw assembly that provides a precise and stable orientation of the jaw's gripping surface, to prevent mislocation of the workpiece.

A further object of the invention is to provide a quick-change removable jaw that does not contribute to wear and looseness within the jaw assembly.

A still further object is to provide a jaw that can be readily changed within a confined space.

The aforementioned objects, features and advantages of the invention will, in part, be pointed out with particularity, and will, in part, become obvious from the following more detailed description of the invention, taken in conjunction with the accompanying drawings, which form an integral part thereof.

### BRIEF DESCRIPTION OF THE DRAWINGS

FIG. 1 is a perspective view of a portion of a machine table and a soft jaw assembly constructed in accordance with a first embodiment of the invention.

FIG. 2 is a perspective view of the soft jaw assembly of FIG. 1 shown removed from the machine table.

FIG. 3 is an exploded view of the soft jaw assembly of FIG. 1.

FIG. 4 is a side view of the machine table and soft jaw assembly of FIG. 1.

FIG. 5 is a side view of the machine table and soft jaw assembly showing how a workpiece is clamped.

FIG. 6 depicts a perspective view of a portion of a machine table and a soft jaw assembly constructed in accordance with an alternate embodiment of the invention.

FIG. 7 is a perspective view of the soft jaw assembly of FIG. 6 shown removed from the machine table.

FIG. 8 is a side view of the machine table and soft jaw assembly of FIG. 6.

FIG. 9 is a side view of the machine table and soft jaw assembly showing how a workpiece is clamped.

FIG. 10 is a detailed view of the connection between the removable jaw and the soft jaw.

FIGS. 11-13 are side views showing how the removable jaw is attached to the soft jaw.

FIG. 14 is an exploded view showing the removable jaw detached from the soft jaw.

In the various figures of the drawings, like reference characters designate like parts.

### DETAILED DESCRIPTION OF THE PREFERRED EMBODIMENTS

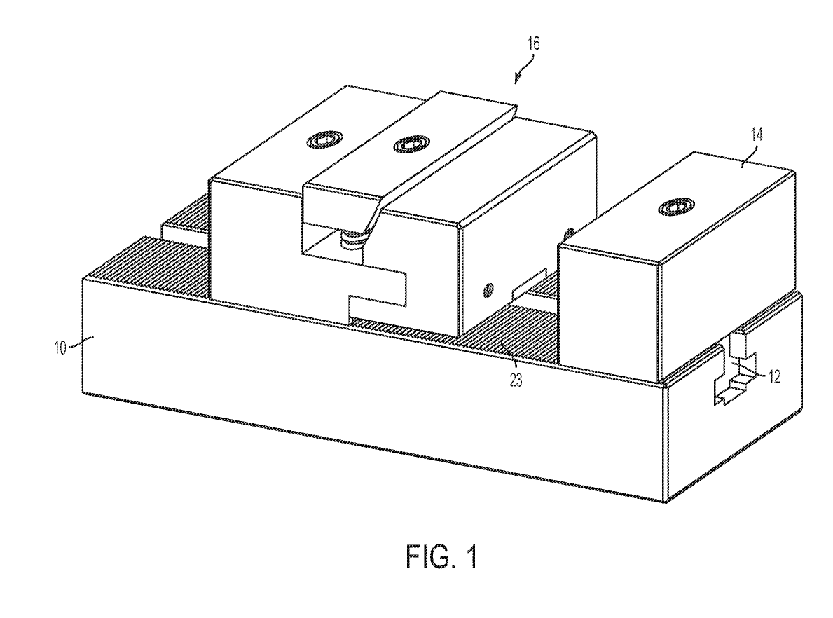

The present invention will now be described in conjunction with the drawings, beginning with FIG. 1 which shows a conventional machine table 10 having slideway 12 formed therein. A hard jaw 14 is rigidly fixed to the machine table 10 in a known manner for forming a vise in combination with a soft jaw assembly 16 which slides into slideway 12.

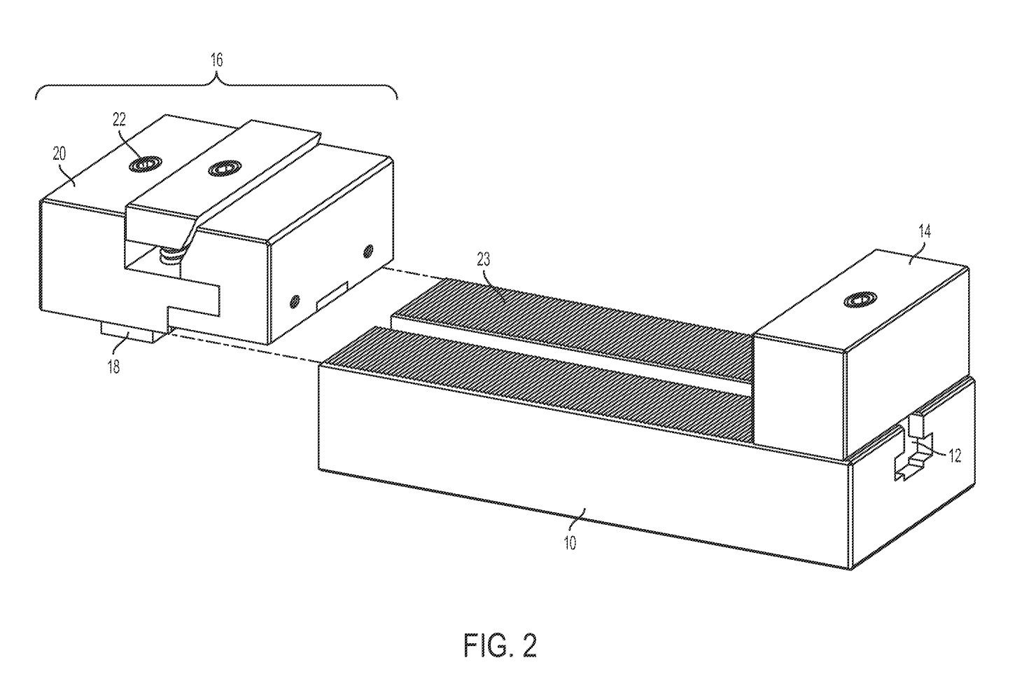

Referring next to FIG. 2, soft jaw assembly 16 is shown removed from machine table 10. The soft jaw assembly 16 includes a slideway connector in the form of adjustable connector 18 which is mounted on the bottom of a jaw holder 20 with threaded fastener. As threaded fastener 22 is tightened, adjustable connector 18, which is spaced apart from the bottom of jaw holder 20, is pulled toward jaw holder 20 and as threaded fastener 22 is loosened, adjustable connector 18 separates from jaw holder 20. Teeth (not currently shown) located on the bottom jaw holder 20 interlock with teeth 23 on machine table 10 as threaded fastener 22 is tightened, thereby preventing any further movement of jaw holder 20 within slideway 12.

Adjustable connector 18 is adapted to slide freely within slideway 12 so as to guide soft jaw assembly 16 toward and away from fixed hard jaw 14. In this manner, a workpiece (not shown) may be clamped to the surface of machine table 10 between hard jaw 14 and soft jaw assembly 16 as described further below.

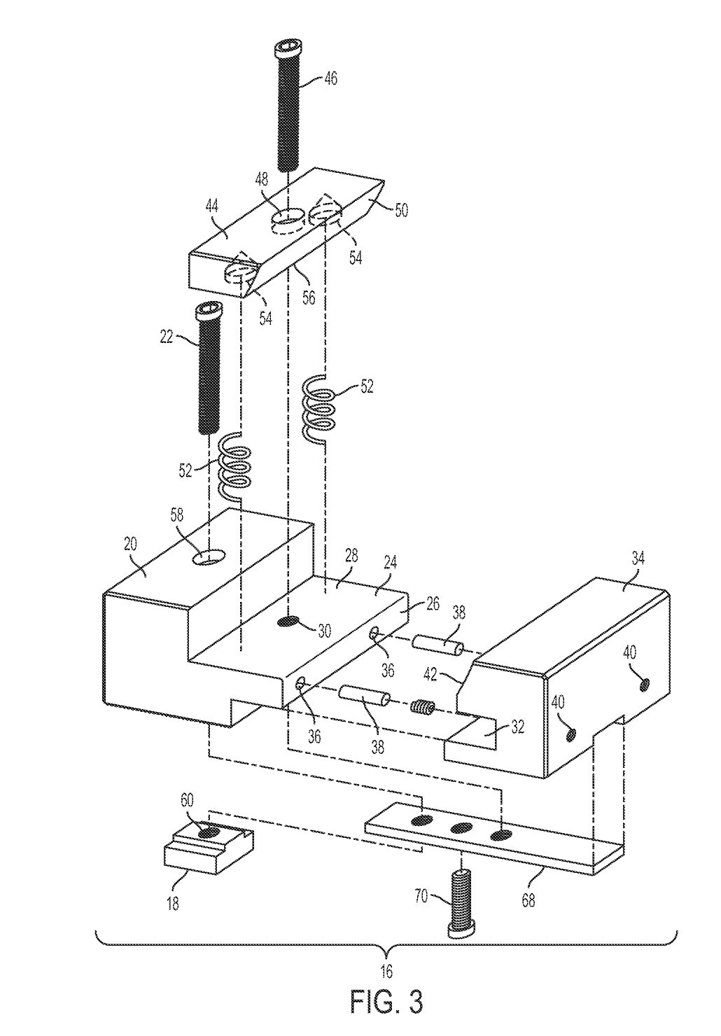

As seen in FIG. 3, jaw holder 20 includes rectangular protrusion 24 having front wall 26 and ledge 28. A threaded bore 30 is formed through ledge 28. Protrusion 24 interlocks with rectangular cutout 32 on soft jaw 34. Front wall 26 has two bores 36 which align with bores 40 on soft jaw 34. Cylindrical guide tubes 38 ensure proper alignment of jaw holder 20 with soft jaw 34. Cylindrical guide tubes 38 may be press fit within bores 36 and 40. The interlocking of rectangular protrusion 24 with rectangular cutout 32 and cylindrical guide tubes 38 with bores 36 and 40 allows soft jaw 34 to slide freely to and away from jaw holder 20. Further, by providing both ledge 28 and rectangular cutout 32 with a rectangular shape allows for jaw holder 28 and soft jaw 34 to be easily machined. Soft jaw 34 has a beveled or inclined wedge face 42 to drive soft jaw 34 toward hard jaw 14 as described below.

In order to drive soft jaw 34 along rectangular protrusion 24 toward the hard jaw 14, a drive member such as drive block 44 is movably and adjustably mounted on jaw holder 20 above ledge 28. Drive block 44 is mounted on ledge 28 with threaded fastener 46 which slides freely into a smooth-walled stepped bore 48 formed through the central portion of drive block 44. Fastener 46 engages threaded bore 30 formed through ledge 28. As fastener 46 is tightened and loosened, drive block 44 respectively moves vertical downwardly and upwardly.

Drive block 44 further includes drive face 50 which is beveled or inclined at the same angle as wedge face 42 on soft jaw 34. Drive face 50 inclines upwardly and away from the jaw holder 20 to engage wedge face 40 with a planar sliding wedging action. In some embodiments, drive face 50 has a slight curvature so allow it to more easily move along wedge face 42. A pair of compression springs 52 is held within a pair of cylindrical recesses 54 formed in the bottom face 56 of drive block 44. Similar cylindrical recesses may also be formed on ledge 28 to accommodate compression springs 52. Springs 52 help to center the drive block 44 on jaw holder 20.

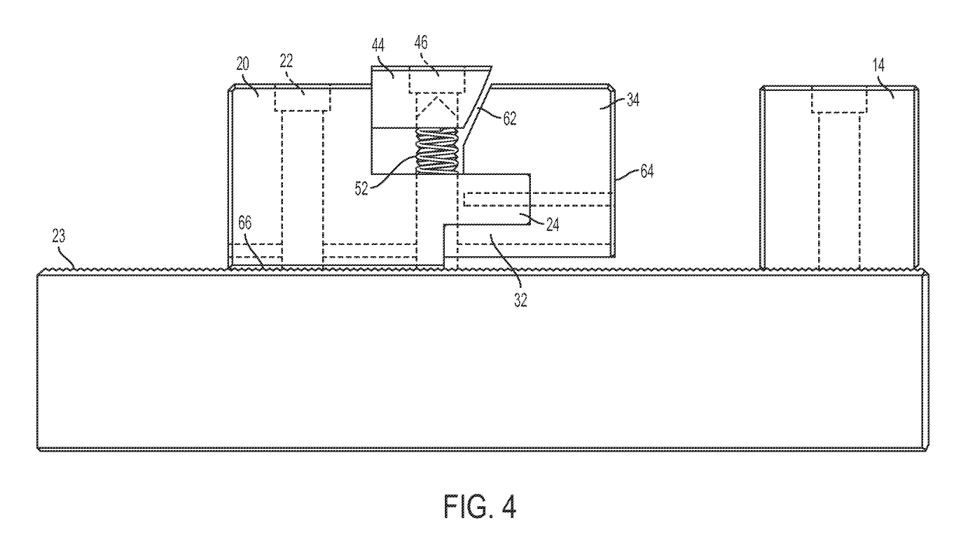

In order to clamp a workpiece on machine table 10 between hard jaw 14 and soft jaw 34, soft jaw assembly 16 is assembled in a somewhat loose configuration as shown in FIG. 4. In this condition, adjustable connector 18 is held loosely below jaw holder 20 as threaded fastener 22 passes through smooth walled stepped bore 58 in jaw holder 20 to loosely engage threaded bore 60 in adjustable connector 18.

As shown in FIG. 3, springs 41 maybe first be fit into bores 40 before cylindrical tubes 38 are inserted. Springs 41 are sized to fit over the ends of cylindrical tubes 38 and a connector located in bores 40. As soft jaw 34 is advanced toward the workpiece, springs 41 provide a counter force that biases soft jaw 34 towards jaw holder 20 as fastener 46 is loosened.

Soft jaw 34 is manually mounted on jaw holder 20 by inserting cylindrical guide tubes 38 into bores 36 and then sliding soft jaw 34 over jaw holder 28 so that rectangular cutout 32 engages rectangular protrusion 24 and bores 40 engage cylindrical guide tubes 38. No permanent or supplemental fasteners are required to hold soft jaw 34 on jaw holder 20. Threaded fastener 46 is threaded in bore 30 to hold drive block 44 loosely above ledge 28. A small gap 62 may be maintained between faces 42 and 50 as seen in FIG. 4.

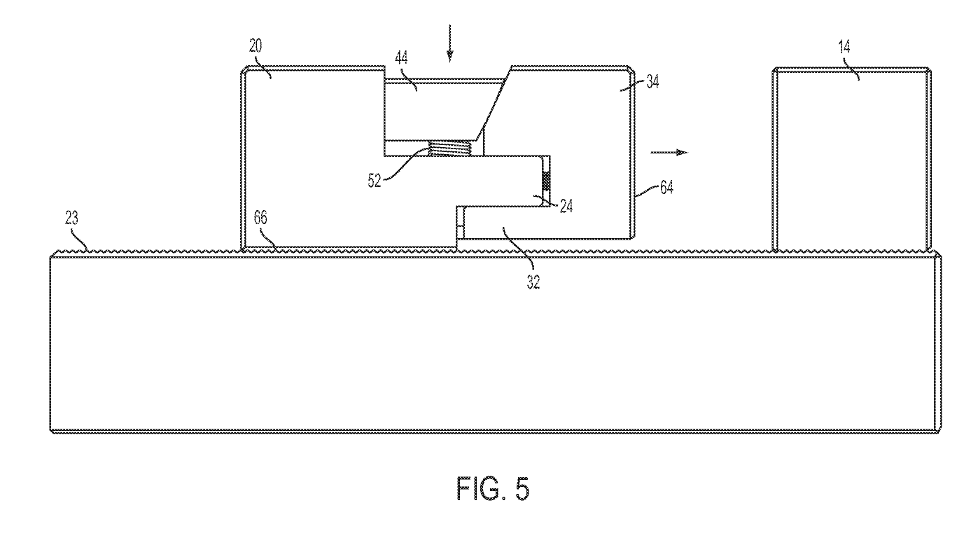

In this condition, soft jaw assembly 16 is mounted to machine table 10 by sliding adjustable connector 18 into slideway 12 (FIG. 1) until the front face 64 of soft jaw 34 pushes a workpiece against hard jaw 14 in the manner of a vise. At this point, the fastener 22 is tightened to lock jaw holder 20 in place over slideway 12. This causes teeth 66 on the bottom of jaw holder 20 to interlock with teeth 23 on machine table 10 to provide a more secure connection and prevent sliding of jaw holder 20. Fastener 46 is then tightened to drive block 44 downward causing the drive face 50 to wedge against wedge face 42 on soft jaw 34 as depicted in FIG. 5. This wedging action causes soft jaw 34 to slide horizontally away from jaw holder 20 over rectangular protrusion 24 and thereby tightly clamp a workpiece in position.

A workpiece is easily removed from between the vise jaws by loosening fastener 46 which allows soft jaw 34 to release the workpiece. If desired, additional release and clearance can be effected by loosening fastener 22 and sliding soft jaw assembly 16 along slideway 12 away from hard jaw 14. A new workpiece can then be placed on machine table 10 in front of hard jaw 14 for clamping by soft jaw assembly 16. Alternatively, soft jaw assembly 16 can be removed from slideway 12 and a different soft jaw 34 can be mounted on soft jaw assembly 16 for clamping a different workpiece.

As depicted in FIG. 3, soft jaw assembly 16 further comprises connection plate 68 which is attached to the underside of jaw holder 20 by fastener 70 through the middle hole of connection plate 68. The underside of jaw holder 20 has a channel (not shown) for accommodating the thickness and width of connection plate 68. The channel on jaw holder 20 is similar to that of channel 70 of soft jaw 34. Threaded fastener 22 passes through the left most hole of connection plate 68 before entering bore 60. Further, the right most hole of connection plate 68 accommodates the bottom of fastener 46 as it is tightened. As connector 46 is tightened to drive drive block 44 downwards, soft jaw 34 additionally slides over connection plate 68 on channel 70. This provides an additional stabilization as soft jaw 34 is advanced toward a workpiece.

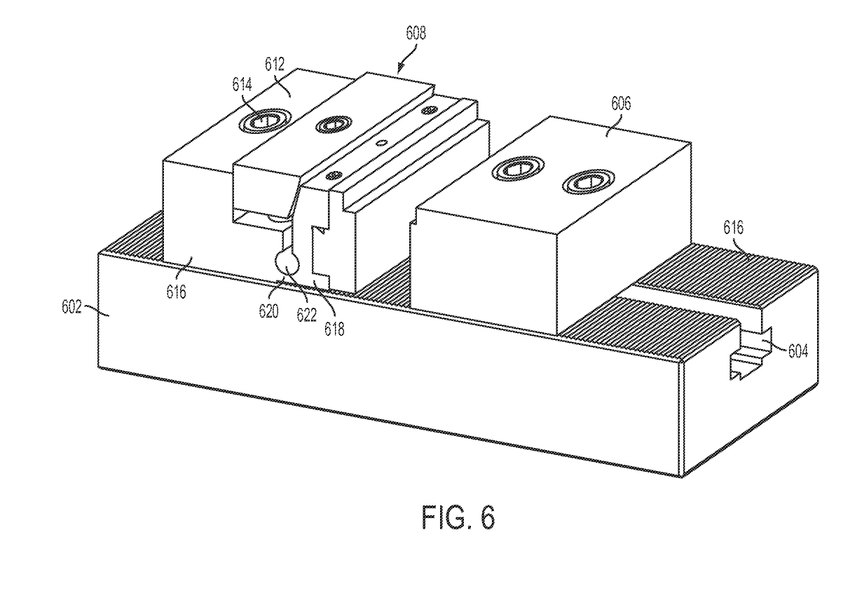

FIGS. 6-14 depict an alternate embodiment of a soft jaw assembly according to the present invention in which the jaw and jaw holder are formed from a single piece of pliable metal such as carbon steel. Further, the soft jaw assembly depicted in FIGS. 6-14 has a removable jaw that can be adapted for use on any soft jaw assembly such as that described in reference to FIGS. 1-5 above. FIG. 6 shows a conventional machine table 602 having slideway 604 formed therein. A hard jaw 606 is rigidly fixed to the machine table 602 in a known manner for forming a vise in combination with a soft jaw assembly 608 which slides into slideway 604.

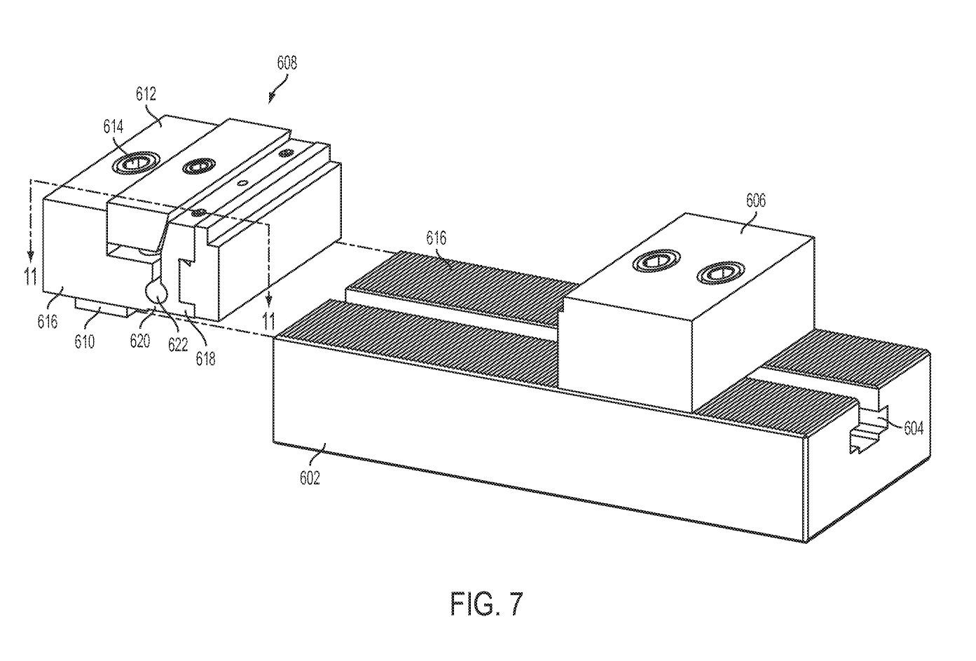

Referring next to FIG. 7, soft jaw assembly 608 is shown removed from machine table 602. Soft jaw assembly 608 includes a slideway connector in the form of adjustable connector 610 which is mounted on the bottom of soft jaw 612 with threaded fastener 614 in a similar manner to that of adjustable connector 18 to jaw holder 20. As threaded fastener 614 is tightened, adjustable connector 610, which is spaced apart from the bottom of soft jaw 612, is pulled toward soft jaw 612 and as threaded fastener 614 is loosened, adjustable connector 610 separates from soft jaw 612. Teeth (not currently shown) located on the bottom soft jaw 612 interlock with teeth 616 on machine table 602 as threaded fastener 614 is tightened, thereby preventing any further movement of soft jaw 612 within slideway 604.

Adjustable connector 610 is adapted to slide freely within slideway 604 so as to guide soft jaw assembly 608 toward and away from fixed hard jaw 606. In this manner, a workpiece (not shown) may be clamped to the surface of machine table 602 between hard jaw 606 and soft jaw assembly 608 as described further below.

Soft jaw 612 is formed from a single piece of metal as shown in FIG. 7. Jaw holder portion 616 is connected to soft jaw portion 618 by flexible connector portion 620 which has a cylindrical cutout 622 which allows soft jaw portion 618 to flex away from jaw holder portion 616 as will be described later.

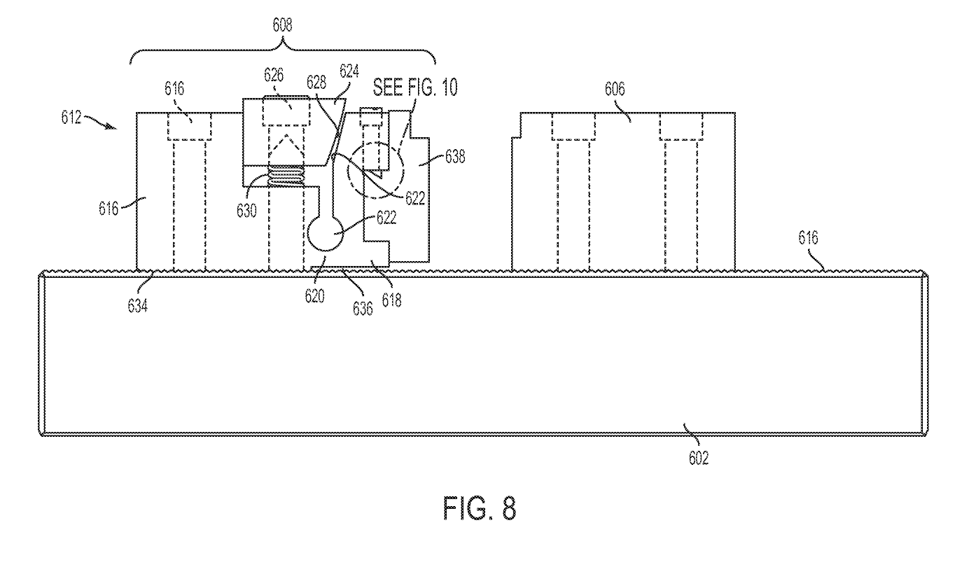

As depicted in FIG. 8, soft jaw portion 618 has a beveled or inclined wedge face 622 to drive soft jaw portion 618 toward hard jaw 606. In order to drive soft jaw portion 618 toward the hard jaw 14, a drive member such as drive block 624 is movably and adjustably mounted on jaw holder portion 616 in a manner similar to that of drive block 44 depicted in FIG. 3. Drive block 624 is mounted on jaw holder portion with threaded fastener 626 which slides freely into a smooth-walled stepped bore formed through the central portion of drive block 624. Fastener 626 engages a threaded bore formed through jaw holder portion 616. As fastener 626 is tightened and loosened, drive block 624 respectively moves vertical downwardly and upwardly.

Drive block 624 further includes drive face 628 which is beveled or inclined at the same angle as wedge face 622 on soft jaw portion 618. Drive face 628 inclines upwardly and away from the jaw holder portion 616 to engage wedge face 622 with a planar sliding wedging action. In some embodiments, drive face 628 has a slight curvature so allow it to more easily move along wedge face 622. A pair of compression springs 630 help to center drive block 624 on jaw holder portion 616.

In order to clamp a workpiece on machine table 602 between hard jaw 606 and soft jaw 612, soft jaw assembly 608 is assembled in a somewhat loose configuration as shown in FIG. 8. In this condition, adjustable connector 610 is held loosely below soft jaw 612 as threaded fastener 616 passes through a smooth walled stepped bore in soft jaw 612 to loosely engage threaded bore adjustable connector 610. Threaded fastener 626 is threaded through drive block 624 into soft jaw 612 to provide a small gap 632 between faces 622 and 628.

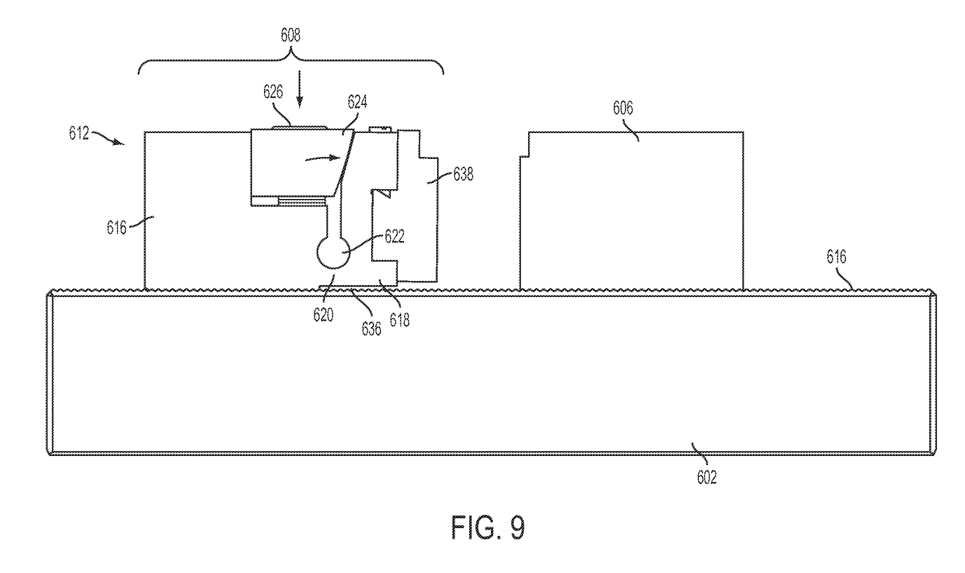

In this condition, soft jaw assembly 608 is mounted to machine table 602 by sliding adjustable connector 610 into slideway 604 (FIG. 1) until the front face of soft jaw assembly 608 pushes a workpiece against hard jaw 606 in the manner of a vise. At this point, the fastener 616 is tightened to lock soft jaw assembly 608 in place over slideway 604. This causes teeth 634 on the bottom of soft jaw 612 to interlock with teeth 616 on machine table 602 to provide a more secure connection and prevent sliding. Fastener 626 is then tightened to drive block 624 downward causing the drive face 628 to wedge against wedge face 622 on soft jaw portion 618 as depicted in FIG. 9. This wedging action causes soft jaw portion 618 to flex away from jaw holder portion 616. Raised step 636 allows soft jaw portion 618 to flex without contacting teeth 616.

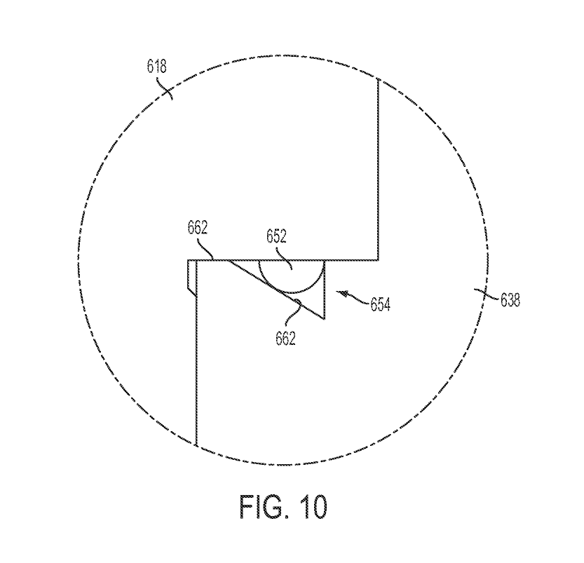

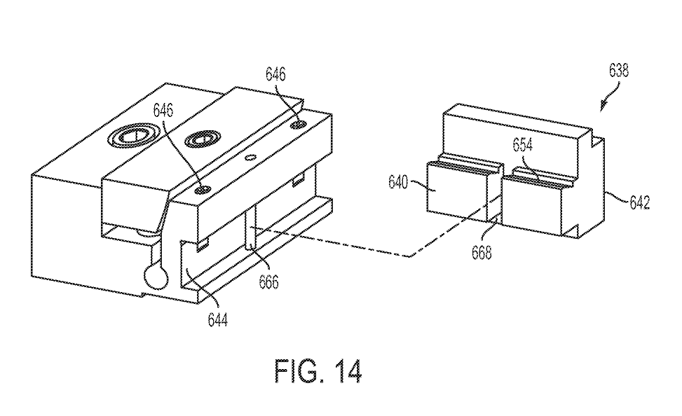

As depicted in FIGS. 6-9, soft jaw assembly 608 further includes removable jaw 638 which is connected to soft jaw portion 618 via a reliable snap fit connection which will be described below with reference to FIGS. 10-14. As shown in FIG. 14, removable jaw 638 has a connector foot 640 opposite a gripping surface 642. Gripping surface 642 can be shaped to accommodate a variety of different workpieces. In the described figure, gripping surface 642 has a flat surface. However, it should be apparent to one skilled in the art that other surfaces, such as a curved surface to accommodate cylindrical objects, can also be used.

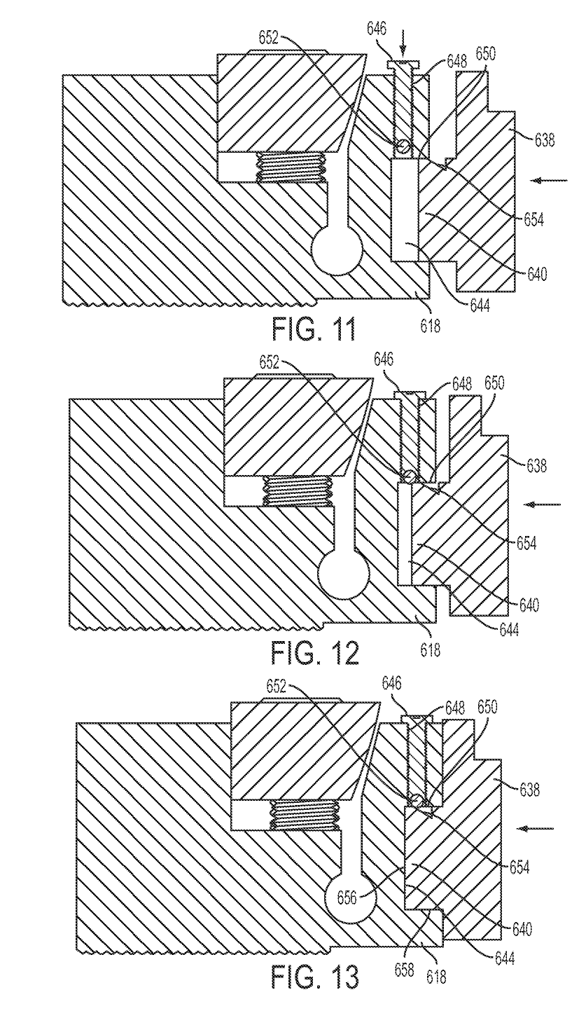

Connector foot 640 is held in channel 644 by the action of ball bearing fasteners 646 as shown in FIGS. 11-13. As shown in FIG. 11, fasteners 646 are first threaded through threaded bore 648 in soft jaw portion 618. Fasteners 646 are tightened until ball bearings 652 extends slightly below flat top portion 650 of channel 644 as shown in FIG. 12. Ball bearings 652 are biased by a spring force at the tip of fasteners 646 so that they can be deflected into an interior channel of fasteners 646 if a counter force is applied. Next, connector foot 640 is inserted into channel 644 causing ball bearings 652 of fasteners 646 to be deflected upwards by angled notch 654 of connector foot 640. When connector foot 640 is fully inserted into channel 644 as depicted in FIG. 13, ball bearing 652 exerts a downward force on angled notch 654, thereby locking removable jaw 638 in place. The downward force provided by ball bearings 652 is partially redirected by angled notch 654 against the two bearing surfaces 656, 658 of soft jaw portion 618. Further, as depicted in FIGS. 11-14, foot 640 comprises flat surface 660 which allows removable jaw 640 to be easily slid horizontally out of channel 644 without the need for pivoting removable jaw 640. This allows removable jaw 640 to be easily removed in a confined space where pivoting would not be possible.

Angled notch 654 is shown in more detail in FIG. 10. As shown, angled surface 654 has a front stepped portion 662 which allows a user to more easily line up removable jaw 638 with soft jaw portion 618. Stepped portion 662 also provides the initial deflection of ball bearings 652 during insertion of removable jaw 638. When removable jaw 638 is full inserted as depicted in FIG. 10, ball bearings 652 extend downward toward angled surface 664 to lock removable jaw 638 onto soft jaw portion 618.

To assure that connector foot 640 is properly aligned with channel 640, channel 644 includes post 666 which aligns with channel 668 in connector foot 640 as shown in FIG. 14. If post 666 is not properly aligned with channel 668, ball bearing fasteners 646 cannot engage with angled notch 654.

To remove removable jaw 638 from soft jaw portion 618, the process shown in FIGS. 11-13 is simply reversed. A user pulls horizontally on removable jaw 638 until there is enough force to overcome the biasing force applied by ball bearings 652. The user does not have to angle removable jaw 638 during insertion. The user can then replace removable jaw 638 with another removable jaw 638 having a different gripping surface 642.

There has been disclosed heretofore the best embodiment of the invention presently contemplated. However, it is to be understood that various changes and modifications may be made thereto without departing from the spirit of the invention.

1. A jaw assembly adapted for use on a slideway of a machine table, comprising:
a jaw holder;
a connector provided on said jaw holder for mounting said jaw assembly in said slideway;
a rectangular protrusion extending from the jaw holder;
a jaw drive provided on said jaw holder;
a jaw operatively associated with said jaw holder;
a channel formed in the jaw, wherein the channel is sized to receive the rectangular protrusion of the jaw holder,
wherein, as the jaw drive is advanced in a downward direction, the jaw slides in a perpendicular direction over the rectangular protrusion.

2. The jaw assembly of claim 1, wherein the jaw drive comprises a curved drive face.

3. The jaw assembly of claim 2, wherein the jaw comprises a wedge face, and
wherein, as the jaw drive is advanced downward, the curved drive face contacts the wedge face to slide the jaw in the perpendicular direction.

4. The jaw assembly of claim 1, wherein the machine table comprises a plurality of teeth, and
wherein a bottom surface of the jaw holder comprises a plurality of teeth that interlock with the plurality of teeth of the machine table.

5. The jaw assembly of claim 1, wherein a bottom surface of the jaw holder and a bottom surface of the jaw comprise a lengthwise groove, and
wherein a connection plate is connected to the bottom side of the jaw holder in the groove.

6. The jaw assembly of claim 5, wherein the connection plate extends along the on the bottom surface of the jaw.

7. A jaw adapted for use on a slideway of a machine table, comprising:
a channel having opposing parallel sides;
at least one ball bearing fastener threaded through a bore in said jaw, wherein a tip of the at least one ball bearing fastener comprises a ball bearing in a shaft of the ball bearing fastener which is biased toward the tip by a spring force;
a removable jaw having a connector foot, wherein a first side of the connector foot is parallel to the opposing parallel sides of the channel and a second side of the removable jaw comprises an angled surface,
wherein the ball bearing extends into the angled surface when the removable jaw is inserted into the channel to hold the connector foot in the channel.

8. The jaw assembly of claim 7, wherein the angled surface comprises a flat top portion that is parallel to the first side of the connector foot.

9. The jaw assembly of claim 8, wherein the flat top portion deflects the ball bearing as the removable jaw is inserted into the channel.

10. The jaw assembly of claim 9, wherein the spring force of the ball bearing presses the ball bearing into the angled surface of the connector foot when the removable jaw is completely inserted.

11. The jaw assembly of claim 7, wherein the channel comprises a post extending between the two parallel sides.

12. The jaw assembly of claim 11, wherein the connector foot comprises a channel for accommodating the post so as to precisely locate the removable jaw in the channel of the jaw.

13. The jaw assembly of claim 7, wherein the removable jaw is inserted into the channel of the jaw without tilting the removable jaw.

14. The jaw assembly of claim 7, wherein an amount that the ball bearing extends into the bore of said jaw is adjusted by rotating said ball bearing fastener.

15. A jaw assembly adapted for use on a slideway of a machine table, comprising:
a jaw holder portion;
a soft jaw portion; and
a flexible connector portion pivotally connecting the jaw holder portion to the soft jaw portion,
wherein the jaw assembly is formed from a single piece of metal, and
wherein the flexible connector portion comprises a cylindrical cutout to allow the soft jaw portion to pivot away from the jaw holder portion.

16. The jaw assembly of claim 15, further comprising:
a drive block connected to the jaw holder portion by a threaded fastener comprising:
a drive face which presses against a wedge face on the soft jaw portion as the drive block is pressed in a downward direction.

17. The jaw assembly of claim 15, wherein as the drive block is pressed in the downward direction, the soft jaw portion pivots away from the jaw holder portion about the flexible connector portion.
a connector provided on said jaw holder for mounting said jaw assembly in said slideway;
a rectangular protrusion extending from the jaw holder;
a jaw drive provided on said jaw holder;
a jaw operatively associated with said jaw holder;
a channel formed in the jaw, wherein the channel is sized to receive the rectangular protrusion of the jaw holder,
wherein, as the jaw drive is advanced in a downward direction, the jaw slides in a perpendicular direction over the rectangular protrusion.
